(19) United States
(12) Patent Application Publication
(10) Pub. No.: US 2018/0330240 A1
(43) Pub. Date: Nov. 15, 2018

(54) From Alien Streams

(71) Applicant: Dual Stream Technology, Inc., Santa Cruz, CA (US)

(72) Inventor: Leopold B. Willner, Santa Cruz, CA (US)

(21) Appl. No.: 15/975,050

(22) Filed: May 9, 2018

Related U.S. Application Data
(60) Provisional application No. 62/602,947, filed on May 12, 2017.

(51) Int. Cl. G06N 5/02

(52) U.S. Cl. CPC G06N 5/02; G06Q 30/0207

(57) ABSTRACT

The present disclosure relates to methods, non-transitory computer readable medium, and apparatus consistent with the present disclosure relate to receiving responses to queries from different, alien to one another in form and substance species of intelligence, including human generated responses and responses provided by intelligent machines when identifying differences between the human sentiment based responses and analytical or functional machine based responses. A method consistent with the present disclosure may receive responses to a query from user devices that are associated with users that are humans, to identify a preferred human query response, preferably out of a selected or trained human swarm, from those received human responses, and to receive a response to the query that was generated by an intelligent machine. This method may then identify that the preferred human query response does not match the machine generated query response, and proceed to a better overall result by means of triangulating between them.

### CROSS REFERENCE TO RELATED APPLICATIONS

The present invention claims priority benefit of U.S. provisional application No. 62/602,947 filed on May 12, 2017 entitled “From Alien Streams” the disclosure of which is incorporated by reference.

### BACKGROUND OF THE INVENTION

### Field of the Invention

The present invention is generally directed to methods and apparatus associated with intelligent systems. More specifically, the present invention compares and initiatives actions using intelligent systems of different species.

### Description of the Related Art

Historically, ever since the dawn of humanity, the human species has benefited from the ability of applying the human mind to solving problems that affect humanity. Because of various factors that include human reason, the ability that humanity has to develop tools and the ability to pass knowledge from generation to generation, the human species has become the most powerful species on planet Earth. The human species has also domesticated various other species, such as horses, dogs, and elephants and has used these other species in symbiotic relationships.

Recently, the human species has begun to create new forms of intelligence in the form of intelligent machines. Commonly referred to as artificial intelligence (AI), intelligent machines come in forms that include computer modeling software, stochastic engines, neural networks, and fuzzy logic. These intelligent machines operate in fundamentally different ways than do the minds of organic species like humans because humans are part logical and part emotional in nature, where AI machines are more computational and are devoid of emotion. This means that people that are members of the human species and AI machines are members of the machine species are alien to each other.

In recent years, AI has been harnessed to perform speech recognition, identify individuals using biometric information (such as fingerprints and retinal scans), play games like chess, and to perform tasks like facial recognition. In these applications, machine intelligence often outperforms humans because the problems associated with interpreting speech, identifying biometric markers, and playing games have a limited or fixed set of rules and because modern computers can perform calculations directed to a limited or fixed set of rules much faster than humans can.

As such, in some applications, machine intelligence is able to perform tasks with a greater degree of accuracy, proficiency, or speed then can be performed by a member of the human species. In yet other instances, human intelligence can perform tasks or make evaluations better than machines can. For example, humans are better than machines at interpreting body language or emotional quest associated with other humans. Humans are also better at performing tasks where an equation cannot be applied to solve a problem that has an emotional component or that has a context that a machine cannot understand.

Humans interpret the world in a different way than machines. In fact contextual information that humans use naturally are alien to machines. In a given situation, humans naturally identify contextual information implied by basic implicit assumptions that humans take for granted. For example, a wife may see her husband carrying a bag of groceries into the house: Did you buy me beer? For humans, the making the contextual association of a trip to the grocery store with the purchase of a commodity, such as beer, is natural. A machine observing the husband carrying a grocery bag, would not have a contextual reference that that bag really contained a consumable, nonetheless a consumable that could provide enjoyment when consumed.

Some of the differences between humans and machines, is that humans can be emotionally driven where machines are not. For example, humans have been known to react panic stock markets when emotionally responding feeling of fear or apprehension, where are machines incapable of panicking stock markets based on fears or apprehensions. In another example male members of a combat group may behave irrationally and try to protect female soldiers in ways that are risky or foolish, where machines would not.

Each particular species of intelligence has biases and limitations. Many of these limitations relate to the fact that sensory systems associated with a particular form of intelligence do not have the capability of perceiving reality 100% accurately. Reality may also be difficult to interpret when a particular problem arises. This is especially true when that particular problem is complex and is not bounded by a limited or fixed set of rules. As such, when a problem has sufficiently complex and has uncertain rules or factors, one particular intelligence may be able to solve that problem at a given moment better than another form of intelligence. Humans can often quickly grasp a dangerous situation in a factory or mine from information interpreted in a context when machines are much less likely to identify that dangerous situation. This may be because machines may not be aware of contextual information that humans take for granted.

Another issue confronting humanity today is a rush to embrace technologies that are immature, that have a high level of complexity, and that are not bounded by a fixed set of rules. For example, there is a rush to user in the use of autonomous vehicles after only a few years of development and stock market traders are more and more reliant upon computer models that drive the buying and selling of stocks. One minor error or one minor miss-interpretation of contextual information can lead an AI system to cause a fatal vehicular crash or to drive the economy into a recession/depression via a stock market crash. Because of this, an overreliance on any one form of intelligence may cause actions to be initiated that have negative consequences, when an incorrect answer leads to inappropriate actions, the consequences could be very significant. As such, an overreliance on a particular type of intelligent species may lead to an incorrect answer as compared to systems and methods that review contrasting answers from different forms of intelligence to answer a question. What are needed are systems and methods that identify answers that are more likely to result in a preferred outcome when complex problems that include sufficient uncertainty are being solved (where uncertainty here does not simply mean unknown, but, instead, is the uncertainty of results from real world situations out of stochastic processes whose probability distributions are themselves in flux or changing, or out of the game playing of intelligent actors).

### SUMMARY OF THE PRESENTLY CLAIMED INVENTION

Methods, non-transitory computer readable medium, and apparatus consistent with the present disclosure relate to receiving responses to queries from different forms of intelligence, including human generated responses and responses provided by intelligent machines when identifying differences between the human responses and the machine response. A method consistent with the present disclosure may receive responses to a query from user devices that are associated with users that are humans, to identify a preferred human query response from those received human responses, and to receive a response to the query that was generated by an intelligent machine. This method may then identify that the preferred human query response does not match the machine generated query response to a statistically significant degree, based on the preferred human query response being associated with the certainty level that has at least met the statistical threshold.

When methods consistent with the present disclosure are implemented as a non-transitory computer readable medium by a processor executing instructions out of a memory. Here again the method may include receiving responses to a query from user devices that are associated with users that are humans, identify a preferred human query response from those received human responses, may receive a response to the query that was generated by an intelligent machine, where the processor executing instructions out of the memory may then identify that the preferred human query response does not match the machine generated query response to a statistically significant degree, based on the preferred human query response being associated with the certainty level that has at least met the statistical threshold.

Apparatus consistent with the present disclosure may include a communication interface, a memory, and a processor that executes instructions out of the memory. Such an apparatus may receive responses to a query from user devices that are associated with users that are humans and may receive a response to the query that was generated by an intelligent machine via the communication interface. The processor executing instructions out of the memory may then, identify a preferred human query response from those received human responses and then identify that the preferred human query response does not match the machine generated query response to a statistically significant degree, based on the preferred human query response being associated with the certainty level that has at least met the statistical threshold.

### BRIEF DESCRIPTION OF THE DRAWINGS

FIG. 1 illustrates a computing device that receives answers from different user devices and from an artificial intelligence processing agent.

FIG. 2 illustrates a computing device that receives answers from different artificial intelligence processing agents.

FIG. 3 illustrates an exemplary computing system that may be used to implement all or a portion of a device for use with the present technology.

FIG. 4 illustrates an exemplary set of steps that may be performed by a computing device that evaluates answers to a question from different species of intelligence.

FIG. 5 illustrates an exemplary computing system that may be used to implement an embodiment of the present invention.

FIG. 6 illustrates a set of exemplary steps that may be performed before answers are received by a species evaluation engine consistent with the present disclosure.

FIG. 7 illustrates an exemplary user interface that may be displayed on a display of a user device.

FIG. 8 illustrates an exemplary graph that may be associated with identifying when a major shift has occurred.

### DETAILED DESCRIPTION

The present disclosure relates to methods, non-transitory computer readable medium, and apparatus consistent with the present disclosure relate to receiving responses to queries from different forms of intelligence that are alien to one another in form and in substance species of intelligence. Methods and apparatus consistent with the present disclosure may include receiving human generated responses and responses provided by intelligent machines when identifying differences between the human sentiment based responses and analytical or functional machine based responses of machines. A method consistent with the present disclosure may receive responses to a query from user devices that are associated with users that are humans, to identify a preferred human query response, preferably out of a selected or trained human swarm, from those received human responses, and to receive a response to the query that was generated by an intelligent machine. Such a method may then identify that the preferred human query response does not match the machine generated query response, and proceed to a better overall result by means of triangulating between the preferred human query response and the machine generated response.

The present disclosure may include comparing results received from different species of intelligence. In certain instances, an answer to a question may be received from persons of the human species and answers to that question may be received from machine species associated with an artificial intelligence system or model. When answers associated with the human species differ from answers provided by a machine species, evaluations may be performed that identify whether an answer associated with the human species is preferred to an answer received from the machine species or visa-versa.

Significant differences in answers provided by a representative of a machine species (artificial intelligence system) as compared to answers provided by individuals of the human species may be associated with issues or problems of sufficient complexity, an amount of uncertainty, and to a context.

Methods and apparatus consistent with the present disclosure may account for fundamental differences between particular species when identifying statically significant differences between different species of intelligence. Given the fact that intelligent machines are driven by data and analytics, such machines are limited to making decisions based on gathering data and performing analytics when making a determination. Humans, however, will collect data regarding a problem and then follow their sentiments, instincts, or sum of human intelligence that may have an emotional component with making a determination within a context. As such, humans may be driven not only by data and analytics, yet by a combination of data, analytics, sentiments, and emotions that may be referred to as the human ‘heart’ that is a sum of a person's human intelligence.

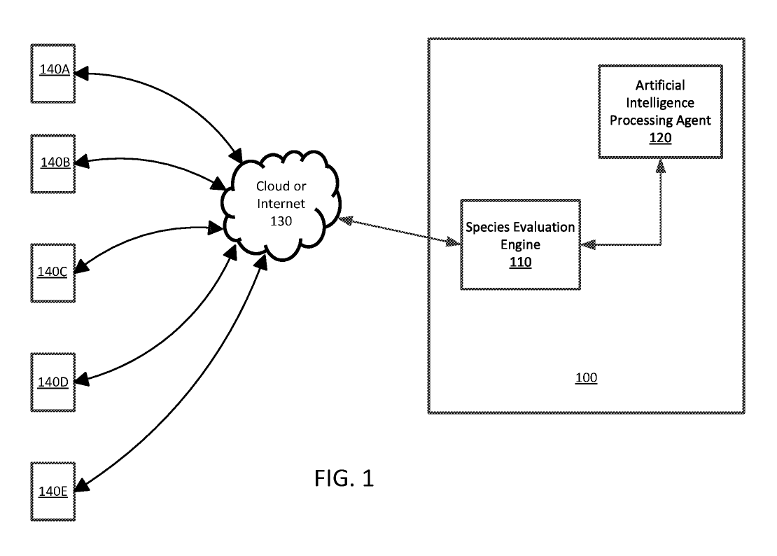

FIG. 1 illustrates a computing device that receives answers from different user devices and from an artificial intelligence processing agent. FIG. 1 includes species evaluation engine 110 that is communicatively coupled to a plurality of user devices (140A, 140B, 140C, 140D, and 140E) and from artificial intelligence processing agent 120. Each of the plurality of computing devices (140A-140E) are depicted as communicating with species evaluation engine 110 via the cloud or Internet 130.

Communications received by the species evaluation engine 110 may include answers to questions. For example, user device 140A may receive an answer to a question from a person using user device 140A and that answer may be transmitted over the cloud or Internet 130 to the species evaluation engine 110. Since people are members of the human species, the person using user device 140A can be considered a member of the human species. Similarly, persons using user devices 140B, 140C, 140D, and 140E may also be considered as members of the human species.

Species evaluation engine 110 may also receive an answer to the question from artificial intelligence processing agent 120. Artificial intelligence agent 120 is a form of intelligence that is not human, instead artificial intelligence agent may be associated with a machine species of intelligence.

Note that FIG. 1 includes species evaluation engine 110 and artificial intelligence processing agent 120 within box 100. This indicates that processes performed by species evaluation engine 110 and processes performed by artificial intelligence processing agent 120 may be contained with a single machine device or computer 100. In such instances, one or more processors at machine device 100 may execute program code out of one or more memories when performing functions associated with species evaluation engine 110 or with artificial intelligence processing agent 120.

Alternatively species evaluation engine 110 and artificial processing agent 120 may be different devices that communicate with each other. In certain instances artificial processing agents may be implemented within more than one machine device including the device that performs functions consistent with species evaluation engine 110.

Methods and apparatus consistent with the present disclosure may be able to discern a best answer to a question associated with a complex and uncertain issue when divergent answers to that question have been received from humans as opposed to a machine.

Such methods may rely on receiving answers generated according to analytical processes independently performed by humans or by machines, may use answers by identified human experts in a field, may receive answers generated by artificial intelligent “bots,” or may receive answers from humans that may be biased by human sentiment.

As such, methods and systems consistent with the present disclosure may identify opportunities, potential pitfalls, and choices related to uncertain potential future events. These methods may then facilitate the selection of a preferred action that will more likely result in a preferred result.

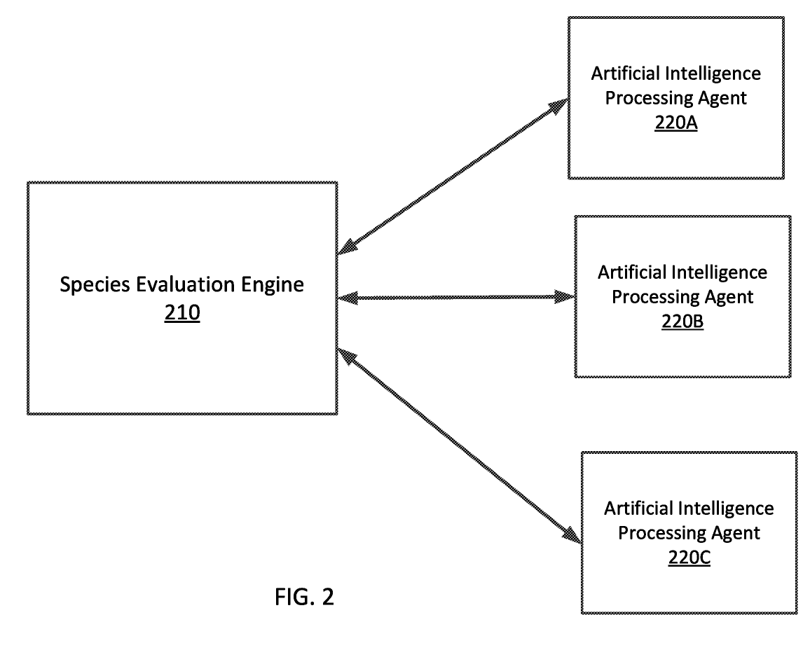

FIG. 2 illustrates a computing device that receives answers from different artificial intelligence processing agents. Note that species evaluation engine 210 may communicate with numerous different artificial intelligence processing agents 220A, 220B, and 220C of a machine species.

One or more of the artificial intelligence processing agents 220A, 220B, and 220C may be included within a single machine device with species evaluation engine 210. Additionally or alternatively one or more of the artificial intelligence processing agents 220A, 220B, and 220C may be included in one or more machines that are physically distinct from species evaluation engine 210.

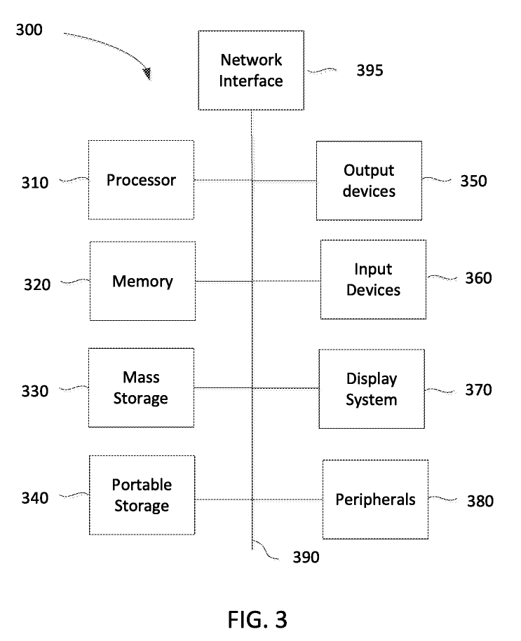

FIG. 3 illustrates an exemplary computing system that may be used to implement all or a portion of a device for use with the present technology. The computing system 300 of FIG. 3 includes one or more processors 310 and memory 320. Main memory 320 stores, in part, instructions and data for execution by processor 310.

Main memory 320 can store the executable code when in operation. The system 300 of FIG. 3 further includes a mass storage device 330, portable storage medium drive(s) 340, a GPS system 345, output devices 350, user input devices 360, a graphics display 370, peripheral devices 380, and a wireless communication system 385. The components shown in FIG. 3 are depicted as being connected via a single bus 390. However, the components may be connected through one or more data transport means. For example, processor unit 310 and main memory 320 may be connected via a local microprocessor bus, and the mass storage device 330, peripheral device(s) 380, portable storage device 340, and display system 370 may be connected via one or more input/output (I/O) buses. Mass storage device 330, which may be implemented with a magnetic disk drive, solid state drives, an optical disk drive or other devices, may be a non-volatile storage device for storing data and instructions for use by processor unit 310. Mass storage device 330 can store the system software for implementing embodiments of the present invention for purposes of loading that software into main memory 320.

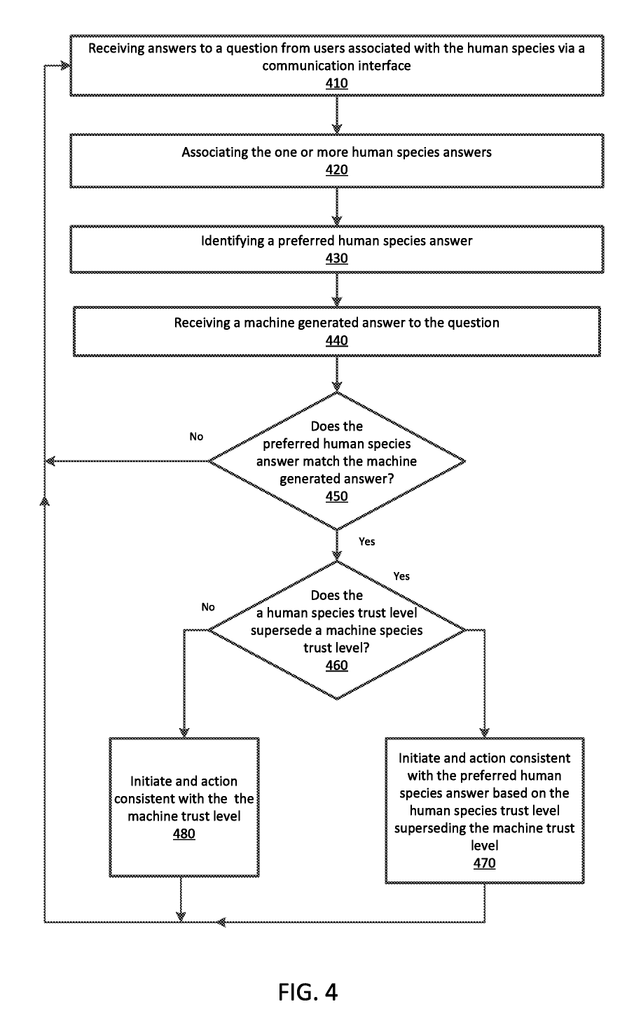

Portable storage device 340 operates in conjunction with a portable non-volatile storage medium, such as a FLASH thumb drive, compact disk or Digital video disc, to input and output data and code to and from the computer system 300 of FIG. 4. The system software for implementing embodiments of the present invention may be stored on such a portable medium and input to the computer system 300 via the portable storage device 340.

Input devices 360 provide a portion of a user interface. Input devices 360 may include an alpha-numeric keypad, such as a keyboard, for inputting alpha-numeric and other information, or a pointing device, such as a mouse, a trackball, stylus, or cursor direction keys. Additionally, the system 300 as shown in FIG. 3 includes output devices 350. Examples of suitable output devices include speakers, printers, network interfaces, and monitors.

Display system 370 may include a liquid crystal display (LCD) or other suitable display device. Display system 370 receives textual and graphical information, and processes the information for output to the display device.

Peripherals 380 may include any type of computer support device to add additional functionality to the computer system. For example, peripheral device(s) 380 may include a modem or a router.

GPS system 345 may include an antenna (not illustrated in FIG. 3) that receives global positioning information from one or more satellites such that a location associated with a current location of computer system 300 may be identified and provided to processor 310 via bus 390.

FIG. 3 also includes a wireless communication system 385 that may include an antenna (not illustrated in FIG. 3). Wireless communication system 385 may be configured to receive or transmit information via any standard wireless communication technology standard in the art. As such, wireless communication system 385 may receive or transmit information according to a wireless (2G, 3G, 4G, blue-tooth, 802.11, light strobes, or other) cellular or device to device standard, or may use radio or optical communication technologies. Wireless communication system may be configured to receive signals directly from pieces of infrastructure along a roadway (such as a signal light or roadway sensors), may be configured to receive signals associated with an emergency band, or may be configured to receive beacons that may be located at a service or emergency vehicle. Computer systems of the present disclosure may also include multiple wireless communication systems like communication system 385.

The components contained in the computer system 300 of FIG. 3 are those typically found in computer systems that may be suitable for use with embodiments of the present invention and are intended to represent a broad category of such computer components that are well known in the art. Thus, the computer system 300 of FIG. 3 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Android, and other suitable operating systems.

FIG. 4 illustrates an exemplary set of steps that may be performed by a computing device that evaluates answers to a question from different species of intelligence. Step 410 of FIG. 4 is a step where answers to a question are received from user devices. The answers received in step 410 may have been initially received over respective user interfaces at respective user devices from users of the user devices, where each of those users is a person. These answers may then have been transmitted from the respective user devices to the computing device that evaluates those answers. Since these users are people, their answers may be associated with the human species in step 420 of FIG. 4.

Next in step 420, a preferred human species answer is identified. The identification of the preferred human species answer may be performed by any one of a number of techniques. For example, in an instance where 11 human species associated answers are received and those answers relate to whether a stock price will increase or decrease. In such an instance, the preferred human species answer may be identified by evaluating whether a number of increase answers are larger than a total number of decrease answers. Alternatively, the preferred human species answer may be identified by evaluating whether a number of decrease answers are larger than a total number of increase answers.

Another way that the preferred human answer may be identified in step 430 of FIG. 4 is by assigning weights to each respective user that has provided an answer. A weight associated with a particular user may be based on the past performance associated with that particular user. After user A provides an answer that proves to be correct, and then the weight associated with user A may be increased from 1.0 to 1.1. Correct answers are responses that correspond to a true result or a response that is proven true, such as when a particular user response or stream of responses forecasts that a stock will be at an increased price tomorrow as compared to the price of that stock tomorrow and indeed that stock price actually is at an increased price tomorrow.

For example, when user A initially begins providing answers, user A may be assigned with a weight of 1.0 that is increased to a weight of 1.1 after user A is associated with providing a certain number (or percentage) of correct answers. Answers indicating that the stock will increase may be associated with a positive number and answers indicating that the stock will decrease may be associated with a negative number. Since user A has a weight of 1.1 and when user A indicates that stock ABC will be at an increased value at 12 noon tomorrow, a vote associated with user A will be weighted with a positive 1.1. When user B has a weight of 0.8 and has provided an answer that stock ABC will be at a decreased value at 12 noon tomorrow, a vote associated with user B will be weighted with a negative 0.8, then the preferred human species answer may be calculated by the formula: preferred human answer=increase when (vote weight of user A+vote weight of user B)>0; or preferred human species answer=decrease when (vote weight of user A+vote weight of user B)<0. Since the vote weight of user A=1.1 and the vote weight of user B=−0.8, then the calculation of the preferred human answer corresponds to (1.1−0.8)=0.3; since 0.3>0, the preferred human species answer identifies that stock ABC will be at an increased value at 12 noon tomorrow as compared to a current price of stock ABC. Such weighted calculations may be performed by comparing weighting factors and vote types (increase vs. decrease) from answers provided by any number of persons.

Since methods and systems consistent with the present disclosure will tend to keep answers provided by different species of intelligence separate, such systems will highlight differences relating to how one species makes decisions regarding a problem as compared to how a second species makes decisions regarding that problem using information or data based on processes that are evaluated by a different species.

Next in step 440 of FIG. 4 the computer may receive a machine generated answer to the question. Then determination step 450 may identify whether the preferred human species answer matches the machine generated answer, when no program back to step 410 where additional answers may be received from at least some of the plurality of user devices.

When determination step 450 identifies that the human species answer does not match the machine generated answer, program flow moves to determination step 460 that identifies whether the human species trust level supersedes a machine trust level, when yes program flow moves to step 470 where an action is initiated consistent with the preferred human species trust level based on the human species trust level superseding the machine trust level. After step 470 program flows back to step 410 where additional answers may be received from at least some of the plurality of user devices.

When determination step 460 identifies that the human species trust level does not supersede the machine trust level, program flow moves to step 480 where an action that is consistent with the machine trust level is initiated. After step 480 program flows back to step 410 where additional answers may be received from at least some of the plurality of user devices.

Embodiments of the present invention may, thus, identify when there is a discrepancy between answers provided by a human species and answers provided by a machine species and then initiate actions commensurate with a preferred trust level.

Answers provided by a first species may be observed overtime, and associations regarding the ranking of particular species members of a species may be used to identify which species members more likely predict future events based on a statistical analysis. As such, particular individual species members may be provide greater weights as compared to other particular members of the same species. Such answers received over time may be associated with a stream of data from a swarm. Human users that consistently provide too many incorrect answers or that do not correctly answer enough questions may be removed (disqualified) from a swarm of human species users.

Over time a unified overall performance of a particular swarm may also facilitate better predictions of future events that may lead to improved hedge fund performance, market forecasts, or improve a security analysis.

Embodiments of method and systems consistent with the present disclosure may, therefore, constitute a new hybridized form of intelligence that learns how to organize, prioritize, and make decisions regarding not only members within a given intelligent species, yet between different intelligent species. As such, systems and methods consistent with the present disclosure may make evaluations based on answers provided by one or more preferred members of a species. These decisions may be made to identify preferred members of the human species and/or to identify preferred member(s) of a machine species, for example. These decisions may also cause certain members of the human species to be removed from a set of human members when those certain members as associated with poorly forecasting future events.

The invention may include a context tracking module in an attempt to capture the context within which both artificial intelligence (AI) and separately a particular swarm may make their evaluations and choices. It is expected that both AI ‘bots’ (automated machines) and the swarm will at times show bias or a disconnect from reality, while the AI will tend to be more fact based yet at times ‘off putting’ and the human swarm will be prone to emotional, tribal, or have other biases.

A human species related swarm of data may include ways and means of capturing human related sentiment data. This human related sentiment data may be biased based on demographic, regional, market segment, or may be related to other types of data types or partitions. Such human related sentiment data may be stored in a database enabled accessibly by a processor executing program codes associated with a powerful statistical software program application/package.

Members of the human species swarm may earn internal human associated credits or tokens (HAT) based on their level of participation and success at making good choices. These credits may be stored in-house in a database or be stored at a third party computing device. In certain instances, particular individuals may earn dividends, interest, credits payments, or other forms of compensation over time. In certain instances such compensation may at any time be converted by a swarm participant into a fungible crypto-currency. Individuals participating in a human swarm may not have or may never have had a bank account, as such, methods consistent with the present disclosure allow individuals to participate in a virtualized banking system where their crypto-currency earns interest over time.

The method may include a sub-system for tracking confidence limits and classify confidence levels based on one or more types of levels of confidence error or success rates. For example, a Type I and Type II statistical errors made over time may cause a weighting factor assigned to a particular member of a species be reduced over time.

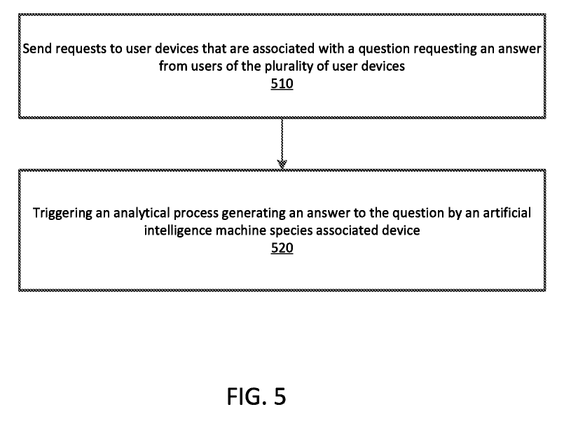

FIG. 5 illustrates an exemplary method for requesting that members of the human species provide answers to a question and that initiates an artificial intelligence system that is associated with a machine species to provide an answer to the question. The steps illustrated in FIG. 5 may be performed before step 410 of FIG. 4.

Step 510 of FIG. 5 may be a step where a species evaluation engine sends questions to each of a plurality of user devices. Once received at the user devices, individual users may provide answers to the question via a user interface at their respective user device. After a user enters an answer that answer may be sent to the species evaluation engine for processing. Each of the respective users that enter answers via their respective user interface may be associated with being a member of the human species that can provide answers associated with the human species.

In step 520 of FIG. 5 the species evaluation engine may trigger at least one analytical process associated with the question to be implemented at a computing device. This analytical process may be related to generating a machine generated answer to the question. The analytical process may be associated with a machine species because their answer to the question is generated by an artificial intelligence associated with a machine. These machine generated answer may be generated by an analytical process that takes place at a computing device that resides with the species evaluation engine or may take place at one or more physically distinct machine devices. Alternatively or additionally machine generated answers may be received from a plurality of different machine devices, may be received from a plurality of different artificial intelligence engines that occur at a particular computing device (like the computing device that implements the species evaluation engine, i.e. a local computer), or may be performed at both a local computer and at one or more external machine devices.

After the questions have been sent to the user devices and after the analytical process has been initiated, steps consistent with the steps of FIG. 4 may be implemented. In such instances, the steps illustrated in FIG. 4 may rely on the species evaluation engine polling user devices and machine processes for answers to a question.

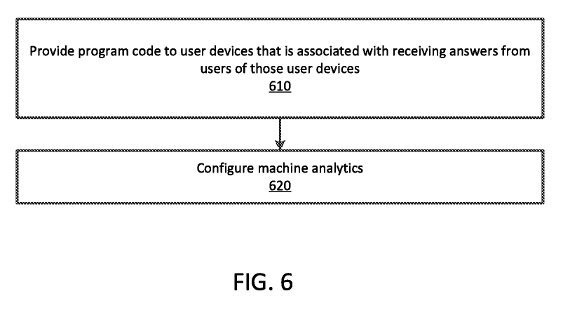

FIG. 6 illustrates an exemplary method for receiving answers to questions from users that are from the human species and from machine processes/devices that are associated with a machine species.

Step 610 of FIG. 6 may include providing program code to a plurality of user devices, the program code provided to the user devices may be an application program that provides questions to user of respective user devices via user interfaces associated with each of those respective user devices.

Users using the received program code may be able to select question topics, categories, or stocks that they wish to provide answers to. For example, a user may be able to select that he will provide answers to what tomorrow's price of Intel stock and AMD stock will be. Based on these user selections, a user may be provided with questions that ask the user to identify whether Intel stock and/or AMD stock will be at a higher price tomorrow than today. In certain instances, times associated with comparing stock today's price with tomorrow's stock price may be set by a user, be set by an administrative policy, be set by a convention or rule, or be set by other means. In certain instances these prices may be set based on an opening stock market in a particular market, like the New York Stock Exchange, for example. In other instances, comparison times may be based on a time that a user provides an answer.

After step 610, step 620 of FIG. 6 may be a step where analytics of a machine process may be initiated. This initiation process may include instructing the machine process to generate answers via a machine analytical process that forecasts the price of Intel stock or AMD stock at tomorrow's opening or closing of a particular stock market. Alternatively or additionally, comparison times may be set by an administrative policy. The machine process may be configured to provide answers every day to one or more questions.

In certain instances intelligent machines may be programmed to provide answers to certain questions periodically, such that a species evaluation engine will not need to poll AI machines for answers to specific questions.

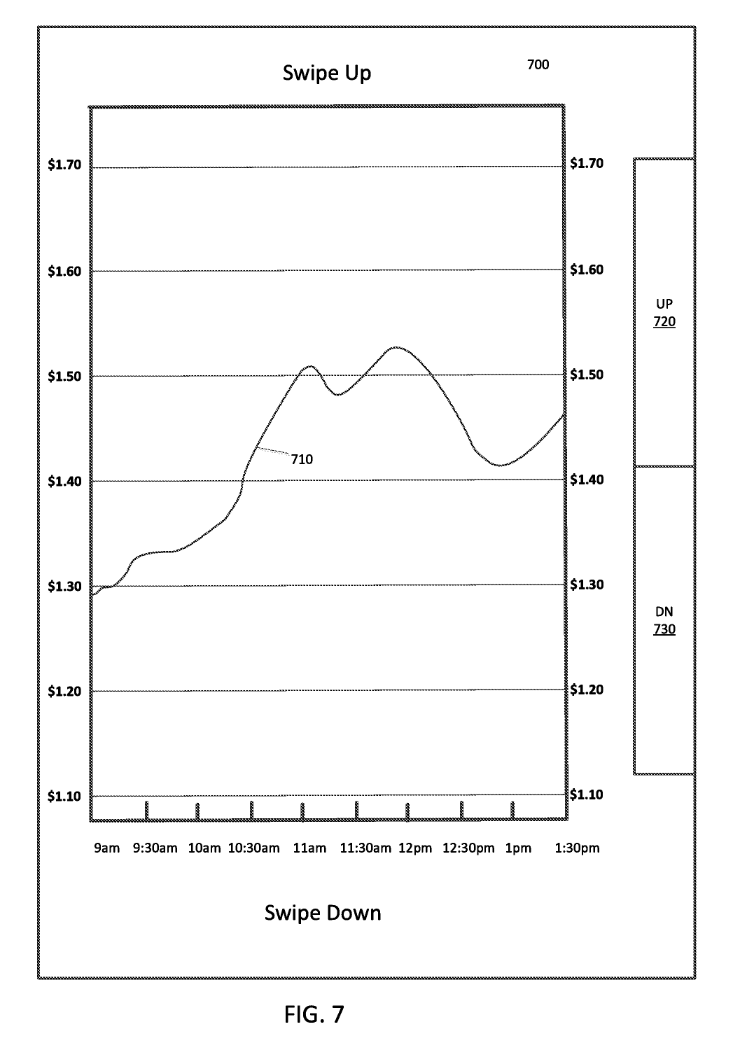

FIG. 7 illustrates an exemplary user interface that may be displayed on a display of a user device. Graphical user interface 700 (GUI) includes a chart 710 of a stock price. Note that chart 710 includes a set of prices along a vertical axis of the chart, where the chart includes prices ranging from $1.10 to about $1.75. Chart 710 also includes times that increase from 9 am to 1:30 pm along a horizontal axis of chart 710.

When a user is presented with chart 710, that user may select that a future stock price will be higher than the current stock price by selecting the UP selection box 720 or by using an up-swipe, ‘swiping up’ by touching the GUI 700 and moving their finger in an upward direction. Alternatively, a user may select that a future stock price will be lower by selecting the DN selection box 730 or by using a down swipe, ‘swiping-down’ by touching the GUI and moving their finger in a downward direction.

A swarm of users may be associated with a specialty or a type of stock. For example, a first user swarm may be associated with technical stocks, a second swarm may be associated with energy, and a third swarm may be associated with banking or finance.

Since an aspect of the present disclosure includes keeping information associated with different species separate, methods and apparatus consistent with the present disclosure may perform tests that identify whether answers coming from a particular source are really coming from a correct species. For example, in an instance where a hacker provides an AI engine (or bot) to provider answers for them as a member of the human species, the actions of that hacker would tend to corrupt the very purpose of systems consistent with the present disclosure. Because of this, a user device may be sent questions that are more likely to be answered by humans better than machines. In such instances a user device may display a group of photographs, some of which include store fronts and the user may be polled to select which photos of that group include the store front. When a group of correct photos are entered via the user interface and are received by a species evaluation engine, that species evaluation engine can identify that answers received from that user device were really provided by a member of the human species. Such a test is merely exemplary as any test that humans are more likely to answer correctly as compared to a member of a machine species may be used to identify whether a certain entity is really a human or not.

Test relating to identifying whether a particular response provider is truly of the human species may also include tests associated with identifying human emotions, senses, and intuition. An exemplary test may include providing visual or audio information or stimulus to a user device for presentation to a user via a display or a speaker of a user device. Pleasant images or music may be displayed or played to a user after which one or more responses may be provided by or received from the user device. The user interacting with a user interface of the user device may provide indications or responses identifying that the currently displayed images or music is pleasant. Alternatively or additionally unpleasant images or sounds may be displayed or played to a user via the user device and an indication that the displayed or played content may be received from the user device. For example, a blasting siren or other unpleasant sound, if cancelled or shut off within a threshold time could indicate that the user device was being operated by a real human based on their quick action to shut down an unpleasant sound (or image).

In yet other instances, sensors or camera at a user device may be used to view a user or to measure a physiological response from a user as that user is provided pleasant and/or unpleasant images or sounds. Physiological responses, such as movements (backing away, looking away, or paying closer attention), changes in heart rate, changes in perspiration rates, or changes in a respiration rate. As such, user devices associated with the present disclosure may also include cameras or sensors that sense human responses to stimulus provided via a display or speaker.

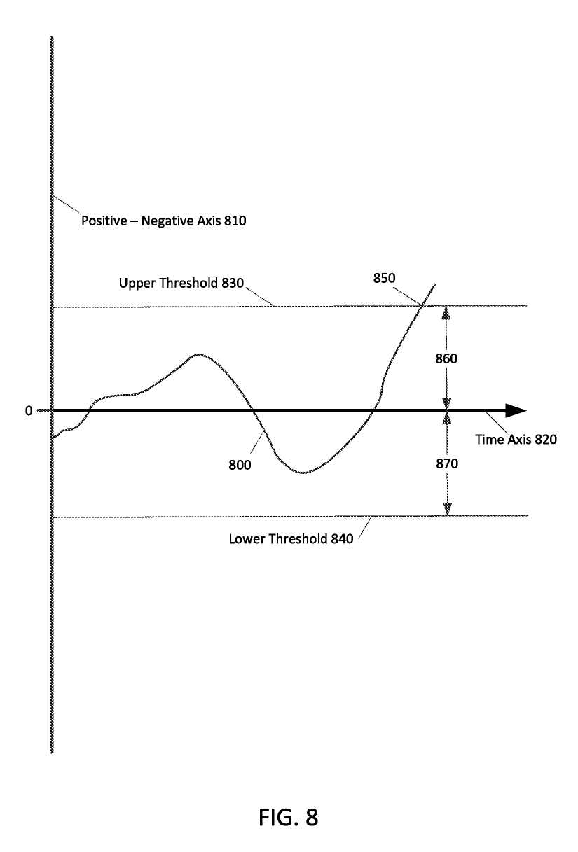

FIG. 8 illustrates an exemplary graph that may be associated with identifying when a major shift has occurred. FIG. 8 includes graph 800 that includes a positive-negative axis (the vertical axis of FIG. 8), a time axis 820 (the horizontal axis of FIG. 8), an upper threshold 830, and a lower threshold 840. Notice that at point 850, graph 800 crosses upper threshold 850.

Note that upper threshold 830 is a distance 860 above null point 0 of FIG. 8 and that lower threshold 840 is a distance 860 below null point 0 of FIG. 8. Null point 0 may be associated with a point of equilibrium, upper threshold 830 may be related to a number associated with a magnitude of change, and lower threshold 840 may be associated with the same or with a different magnitude of change.

Each of these magnitudes of change and thresholds 830/840 may be associated with a number of users or a percentage of users that are providing positive answers as opposed to negative answers at a given moment in time. When graph 800 crosses upper threshold 830 at point 850, an identification that a significant change in votes or forecasts from a human user population/swarm has or is occurring. A significant change is in a positive direction may be indicative of a strong positive sentiment is affecting that human population/swarm and the identification of a strong positive change may cause a larger number of stock shares in a company or class of companies to be purchased as compared to times when chart 800 stays below upper threshold 830 and above lower threshold 840. Conversely, in an instance when a strong negative change is identified in a population, this identification may cause larger number of stock shares to be purchased as compared to times when chart 800 stays below upper threshold 830 and above lower threshold 840 or may cause the short selling of a stock.

While indications of such major changes may be identified using numbers of users or percentages of users voting in a particular direction, the detection of such a major change may be associated with other factors. For example, in an instance where a relatively large number of users have been voting in a positive direction for a span of time, a major shift may only be identified when a number of users or a percentage of the users change to voting in a negative direction or a neutral direction. As such, major shifts may be associated with change in a set of normal patterns and not simply be associated with a particular number or percentage of users forecasting future events. Such major shifts may be used to identify a change in a sentiment of the population of users. For example, the first day or few days of a “bull market” (upwardly driven stock market indexes/prices) may be associated with a market shift, where a continued rise over longer periods of time may be associated with a normal “bull market.” Alternatively, the same may be true for a “bear market” where stock market indexes/prices may be reducing.

In certain instances a stream of answers from a population or from a machine may be identified as not being of sound mind (non-compos mentis). Such identifications may be associated with receiving too many incorrect (above a threshold number) answers from a machine, a species, a user swarm, a machine swarm, or a given population. When a determination that a particular stream of answers is identified as being non-compos mentis, that particular stream may be disregarded, disabled, or be removed from a set of acceptable streams.

Methods and apparatus consistent with the present disclosure may also include a set of decision making rules. One or more of these rules may be associated with hedging a particular investment. In the event where a particular entity currently owns a large amount of stock in a first company from a group of companies, these hedging rules may be used to identify when to invest in a second company that competes with the first company or when to invest in a supplier or customer of either the first or the second company. Note that a technology sector set of stocks may be associated with the stocks that include DELL products, Seagate Corp., Western Digital Corp, Intel, and a magnet supplier for example. Seagate and Western digital both sell disk drives to computer manufactures like DELL products, Intel sells microprocessors and other integrated circuits (chips) to DELL, and the magnet supplier may sell rare earth magnets to both Seagate and to Western Digital. Since Seagate and Western Digital are both disk drive companies, these companies may be classified as being data storage providers. Different streams of information relating to the price of DELL stock, Seagate stock, Western Digital stock, Intel stock, and the stock of the magnet supplier may be evaluated. As demand for certain products vary, commonly the suppliers of computer companies are first to feel the impact of a financial slowdown and are first to feel the stimulus at the beginning of a financial boom. As such, a stream of information that identifies that the price of Intel's stock is decreasing may be indicative of a reduction in the price of Seagate, Western Digital, and the magnet company stocks are likely. This in turn may cause those stocks to be sold short or to be reduced in one's portfolio based on a hedging rule.

Alternatively, hedging rules may be associated with changes in market distribution between one vendor and another. For example, certain information may indicate that Seagate is losing market share to Western Digital and that based on a hedging rule, Western Digital stock should be purchased, or that Seagate stock should be sold (or sold short).

In yet another example, a hedging rule may be associated with the price of gold (or forecasted a gold stream price) and with a peace index stream. In such an instance the peace index stream may be related to potential violence in parts of the world that may affect the current price of gold. When the peace index stream identifies that a potential for violence in those parts of the world has increased or decreased, then a hedging rule could cause gold to be purchased or sold. Here again actions related to buying or selling may be based on general indicators, a total number of responses, weighted responses, or be based on the identification of a major change.

In certain instances, differences identified between different streams of information may or may not be statistically significant. An AI stream could indicate that a stock should be sold and a human stream could indicate that the stock should be purchased, yet the human stream could include attributes that associate the stock with a weak buy position. As such, buy or sell indications of a give species may be associated with metrics of weakness or strength. For example, when 510 of 1000 of user responses indicate that a certain stock should be purchased, the stock may be associated with a weak buy. In such an instance, when an AI stream indicates this same stock should be sold, the difference between the two streams may be considered not statistically significant. In such instances a strong buy or sell indication may be associated with a threshold ratio of buy versus sell responses, a threshold percentage of buy versus sell responses, or a strong indication may be identified by performing a statistical analysis or historical analysis. Alternatively, threshold ratios or percentages or statistical/historical analysis may be used to identify strong sell indications, weak sell indications, or weak buy indications of a stream. Statistically significant differences may be associated with data sets that are large enough to represent populations of information that provide an indication that is greater than a threshold level that may be associated with ratios, percentages, chances, probabilities, error rates, or a significance level. The statistical significance of a set of human responses or a preferred human response may be associated with a certainty level. For example, a certainty level associated with human query responses or with a preferred human query response that is related to a number of human responders, users, with weights associated with favored human responders, or with a sample size that is greater than a margin of error. A preferred human response may be considered statistically significant when a preferred human query response is at or above a statistical threshold.

Biases of particular individuals or streams of information (machine/AI stream or a human stream) may also be identified. Biases may be associated with an offset, for example in an instance where a stream or an individual provides responses that are associated with a magnitude, if that magnitude is within a threshold distance of an absolute correct answer magnitude, then such responses may be identified as being correct, just offset from particular correct response. Such a user or stream may then be judged as correct, yet biased. Such a bias could be identified and used when making buy or sell decisions according to methods consistent with the present disclosure.

Methods and apparatus of the present disclosure may also include information relating to real-world contextual information or information associated with the physical world. For example, a human stream may provide information regarding the weather where users are located. Indications can be received from user devices as part of a regional stream associated with a locality (city, state, or other location). These indications could identify that the weather is getting better or worse. That a tornado is approaching or moving away from my neighborhood, that rain is increasing or decreasing, that a river is rising or lowering, that flood waters are getting higher or are abating, that winds are increasing or decreasing, or that fire is moving in a certain direction. This human stream may be contrasted with a weather prediction stream that predicts the course of a storm and could be used to issue alerts to areas identified with risk to life or property with greater certainty. Machine intelligence may benefit from information sensed by sensing stations, by Doppler radar, or by infrared or other instrumentation, for example, when assessing whether and where risk reports or evacuation orders should be issued. Alternatively, a human stream may be associated volatility of a region of the world based at least in part on observations made by individuals in a particular locality. Sensor data that senses loud noises, smoke, or other disruptions may be use by a machine intelligence when identifying weather an area should be associated with a risk. As such, real world information provided by users can be contrasted with information from AI systems when validating that a risk is real, where a sophisticated enough AI system may be able to identify the location of a particular risk based on sensor data.

As much as humans and intelligent machines are different species, different members of the animal kingdom are also different species from either humans or intelligence species that are each alien from each other. The universe at large may also include beings that are forms of intelligent species that are alien to humans, animals, or intelligent machines.

The present invention may be implemented in an application that may be operable using a variety of devices. Non-transitory computer-readable storage media refer to any medium or media that participate in providing instructions to a central processing unit (CPU) for execution. Such media can take many forms, including, but not limited to, non-volatile and volatile media such as optical or magnetic disks and dynamic memory, respectively. Common forms of non-transitory computer-readable media include, for example, a FLASH memory, a flexible disk, a hard disk, magnetic tape, any other magnetic medium, a CD-ROM disk, digital video disk (DVD), any other optical medium, RAM, PROM, EPROM, a FLASHEPROM, and any other memory chip or cartridge.

While various flow diagrams provided and described above may show a particular order of operations performed by certain embodiments of the invention, it should be understood that such order is exemplary (e.g., alternative embodiments can perform the operations in a different order, combine certain operations, overlap certain operations, etc.).

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claim.

2. The method of claim 1, wherein each of the human query responses are associated with a human species and the machine query response is associated with a machine species and the method further comprising:
identifying that a human species trust level currently supersedes a machine trust level; and
initiating an action consistent with the preferred human query response answer based on the human species trust level currently superseding the machine trust level.

3. The method of claim 1, further comprising:
sending requests to the plurality of user devices, the requests are associated with receiving the human query responses; and
triggering at least one analytical process at a computing device for generating at least one machine generated answer to the question, wherein the at least one analytical processes are performed by a processor executing instructions out of a memory at the computing device.

4. The method of claim 1, further comprising:
receiving a true result associated with the query;
identifying an individual user that provided a response that matched the true query result; and
increasing a first user trust level associated with the individual user that provided the matching response relative to at least a second user trust level associated with a particular user that provided a response that did not match the true query result.

5. The method of claim 4, further comprising:
identifying that the second user trust level is below a threshold level; and
removing the particular user from a user group associated with the query based on the identification that the second user trust level is below the threshold level.

6. The method of claim 1, wherein the first set of human input is associated with a price of an asset at present time and a true query response is associated with the price of the asset at a first future point in time:
receiving a second set of human input associated with the information stream via the communication interface, the second set of human input is associated with a price of the asset at a second future point in time;
receiving a third set of human input associated with the information stream via the communication interface, the third set of human input is associated with a price of the asset at a second future point in time;
adjusting a trust level associated with a particular user of the users of the user devices;
identifying that the second user trust level is below a threshold level; and
removing the particular user from a user group associated with the query based on the identification that the second user trust level is below the threshold level.

7. The method of claim 1, further comprising providing compensation to the individual user for providing the response that matched the true query response.

8. The method of claim 7, wherein the compensation is includes a portion of cryptocurrency.

9. The method of claim 1, further comprising:
sending a test question to a user device, the test question associated with a task that a member of a human species is more likely to answer correctly than a member of a machine species;
receiving a test question response from the user device to the test question;
identifying whether the test question response from the user device is correct; and
validating that the response to the test question was received from the member of the human species when the received test question response is correct.

10. The method of claim 9, further comprising identifying that that the response to the test question was received from a member of the machine species when the received test question response is incorrect.

11. The method of claim 1, further comprising:
comparing the first set of human responses to the query responses with one or more sets of previous received sets of human responses to the query;
identifying that the first set of human responses has shifted at least by a threshold amount as compared to the one or more previous received sets of human responses to the query; and
initiating an action based on the identified shift.

12. The method of claim 1, further comprising:
receiving a plurality of other sets of query responses to another query from at least a human species and from a machine species via a human associated stream of responses and a machine associated stream of responses;
identifying that at least one of the human species or the machine species has provided an amount of incorrect answers that crosses a not of sound mind threshold; and
disqualifying the at least one of the human species or the machine species based on the at least one of the human species or the machine species providing the amount of incorrect answers that crosses the not of sound mind threshold.

13. The method of claim 1, further comprising:
receiving another set of query responses to another query from a human species swarm of users and from a machine species via a human associated stream of responses and a machine associated stream of responses;
identifying a preferred response to the another query from the human species user swarm;
comparing the preferred response from the human species user swarm with a response to the another query from the machine species;
identifying whether the preferred human species another query response or the response to the query from the machine species is more likely to forecast a future event associated with a first company;
accessing a rule, the rule associated with buying or selling a stock associated with a second company based on the more likely forecasted future event.

14. The method of claim 1, further comprising:
sending information to a user device for presentation to a user of the user device via a user interface, the user interface including at least one of a display or a speaker, wherein the information is displayed on the display or is transmitted over the speaker; and
receiving an indication from the user device, the indication associated with a user interacting with the user device to stop at least one of the information from being displayed on the display or to stop the information from being transmitted over the speaker.

15. The method of claim 1, further comprising:
receiving responses from one or more user devices, the responses associated with the physical world;
identifying that the received physical world responses are significant; and
initiating an action based on the identification that the received physical world responses are significant.

16. A non-transitory computer-readable storage medium having embodied thereon a program executable by a processor for performing a method of detecting divergence in information streams from at least a first input stream that is alien to at least one other input source, the method comprising:
receiving a first set of human input via an information stream via a communication interface, the first set of human input sent from a plurality of user devices in response to a query and including human query responses by users of the user devices, the query associated with forecasting an uncertain future outcome;
identifying a preferred human query response regarding the forecasting of the uncertain future outcome based on an analysis of the human information stream and prevalence of the preferred human query responses among the received human query responses;
receiving a machine-generated query response to the query, the machine-generated query response generated by a computing device based on an information stream separate and distinct from the preferred human query response;
identifying that the preferred human query response is associated with a certainty level that has at least met a statistical threshold; and
identifying that the preferred human query response not match the machine-generated query response to a statistically significant level, based on the preferred human query response being associated with the certainty level that has at least met the statistical threshold.

17. The non-transitory computer-readable storage medium of claim 16, wherein each of the human query responses are associated with a human species and the machine query response is associated with a machine species and the method further comprising:
identifying that a human species trust level currently supersedes a machine trust level; and
initiating an action consistent with the preferred human query response answer based on the human species trust level currently superseding the machine trust level.

18. The non-transitory computer-readable storage medium of claim 17, the program further executable to:
send requests to the plurality of user devices, the requests are associated with receiving the human query responses; and
trigger at least one analytical process at a computing device for generating at least one machine generated answer to the question, wherein the at least one analytical processes are performed by a processor executing instructions out of a memory at the computing device.

19. The non-transitory computer-readable storage medium of claim 17, further comprising:
receiving a true result associated with the query;
identifying an individual user that provided a response that matched the true query result; and
increasing a first user trust level associated with the individual user that provided the matching response relative to at least a second user trust level associated with a particular user that provided a response that did not match the true query result.

20. An apparatus for detecting divergence in information streams from at least a first input stream that is alien to at least one other input source, the apparatus comprising:
a network interface that receives a first set of human input via an information stream via a communication interface, the first set of human input sent from a plurality of user devices in response to a query and including human query responses by users of the user devices, the query associated with forecasting an uncertain future outcome;
a memory; and
a processor that executes instructions out of the memory to:
identify a preferred human query response regarding the forecasting of the uncertain future outcome based on an analysis of the human information stream and prevalence of the preferred human query responses among the received human query responses,
receive a machine-generated query response to the query, the machine-generated query response generated by a computing device based on an information stream separate and distinct from the preferred human query response,
identify that the preferred human query response is associated with a certainty level that has at least met a statistical threshold, and
identify that the preferred human query response not match the machine-generated query response to a statistically significant level, based on the preferred human query response being associated with the certainty level that has at least met the statistical threshold.
